(19) United States
(12) Patent Application Publication
(10) Pub. No.: US 2002/0082381 A1
(43) Pub. Date: Jun. 27, 2002

(54) Polyester molding composition

(76) Inventors: Bret Ja Chisholm, Clifton Park, NY (US); William David Richards, Scotia, NY (US); Timothy Edward Banach, Scotia, NY (US)

Correspondence Address: Robert E. Walter, General Electric Company, One Plastics Avenue, Pittsfield, MA, 01201, US

(21) Appl. No.: 09/745,456

(22) Filed: Dec. 21, 2000

(51) Int. Cl. C08G 79/08

(52) U.S. Cl. 528/272; 528/295; 528/302; 528/308; 528/6

(57) ABSTRACT

A polyester ionomer composition comprises an alkylene aryl polyester copolymer having metal sulfonate units represented by the formula IA:

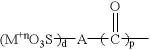

or the formula IB:

(M⁺ⁿO₃S)_{d}—A—(OR″O)ₚ—

where p=1-3, d=1-3, p+d=2-6, n=1-5, M is a metal, and A is an aryl group containing one or more aromatic rings where the sulfonate substituent is directly attached to an aryl ring, R″ is a divalent alkyl group and the metal sulfonate group is bound to the polyester through ester linkages, and having end groups consist essentially of carboxylic acid groups (—COOH) and hydroxyl groups (—OH) having a ratio of —COOH/—OH of 0.1 to 5.

### FIELD OF THE INVENTION

The invention relates to a polyester ionomer composition.

### BACKGROUND OF THE INVENTION

As described in U.S. Pat. No. 6,066,694 to Chisholm et al., the utilization of alkylene aryl polyester copolymers having metal sulfonate units in blends with polycarbonate, polyester carbonates, and polyarylates can result in enhanced properties. The use of a metal sulfonate polyester copolymer modifies the rheology of the blends, especially under low shear where the melt strength is enhanced. Enhanced melt strength is very beneficial in facilitating processing under low shear conditions like blow molding and extrusion, it may also be useful for enhanced thermoformability.

It is desirable to make even further improvements to alkylene aryl polyester copolymers having metal sulfonate units which may result in additional enhancements to polymer blends.

### SUMMARY OF THE INVENTION

We have found that enhancements in properties provided by the incorporation of sulfonate groups are dependent on the polymer end-group composition. In general, carboxylic acid end-groups diminish the properties that are imparted by the sulfonate functionality. The sulfonate groups and carboxylic acid end-groups exhibit an antagonistic interaction. As a result, it is desirable to have ionomers with a low acid end group or, conversely, a high hydroxyl end group composition.

The thermoplastic resin composition of the invention comprises an alkylene aryl polyester copolymer having metal sulfonate units represented by the formula IA:

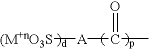

or the formula IB:

(M⁺ⁿO₃S)_{d}—A—(OR″O)ₚ—

where p=1-3, d=1-3, p+d=2-6, n=1-5, M is a metal, and A is an aryl group containing one or more aromatic rings where the sulfonate substituent is directly attached to an aryl ring, R″ is a divalent alkyl group and the metal sulfonate group is bound to the polyester through ester linkages. The end groups consist essentially of carboxylic acid groups (—COOH) and hydroxyl groups (—OH) having a ratio of —COOH/—OH of 0.10 to 5.00.

According to other embodiments, the above polyester may have additional ingredients such as: other resins, fillers, reinforcements, stabilizers, flame retardants and rubbery impact modifiers.

### BRIEF DESCRIPTION OF THE DRAWINGS

FIG. 1 illustrates end group and Mn changes during the solid state polymerization of B1.

FIG. 2 illustrates end group and Mn changes during the solid state polymerization of B2.

### DETAILED DESCRIPTION OF PREFERRED EMBODIMENTS

The term polyester ionomer, or sulfonate polyester or metal sulfonate polyester, refers to polyester polymers derived from the reaction residue of an aryl carboxylic sulfonate salt, an aromatic dicarboxylic acid, an aliphatic diol or any of their ester forming derivatives. The ionomer polyester polymers comprise somesulfonate salt units represented by the formula IA or IB.

A is an aryl group containing one or more aromatic rings: for example, benzene, naphthalene, anthracene, biphenyl, terphenyl, oxy diphenyl, sulfonyl diphenyl or alkyl diphenyl, where the sulfonate substituent is directly attached to an aryl ring. These groups are incorporated into the polyester through carboxylic ester linkages. The aryl groups may contain one or more sulfonate substituents; d=1-3 and may have one or more carboxylic acid linkages; p=1-3. Groups with one sulfonate substituent (d=1) and two carboxylic linkages (p=2) are preferred. M is a metal, n=1-5. Preferred metals are alkaline or alkaline earth metals where n=1-2. Zinc and tin are also preferred metals. R″ is a alkyl group, for example, —CH₂CH₂—, —CH₂CH₂OCH₂CH₂—, —CH(CH₃)CH₂—, CH₂CH₂CH₂—, —CH₂CH₂CH₂CH₂—.

Typical sulfonate substituents that can be incorporated into the metal sulfonate polyester copolymer may be derived from the following carboxylic acids or their ester forming derivatives; sodium sulfo isophthalic acid, potassium sulfo terephthalic acid, sodium sulfo naphthalene dicarboxylic acid, calcium sulfo isophthalate, potassium 4,4′-di(carbomethoxy) biphenyl sulfonate, lithium 3,5-di(carbomethoxy)benzene sulfonate, sodium p-carbomethoxy benzene sulfonate, dipotassium 5-carbomethoxy-1,3-disulfonate, sodio 4-sulfo naphthalene-2,7-dicarboxylic acid, 4-lithio sulfophenyl-3,5-dicarboxy benzene sulfonate, 6-sodiosulfo-2-naphthyl-3,5-dicarbomethoxy benzene sulfonate and dimethyl 5-[4-(sodiosulfo) phenoxy] isophthalate. Other suitable sulfonate carboxylic acids and their ester forming derivatives are described in U.S. Pat. Nos. 3,018,272 and 3,546,008 which are included herein by reference. The most preferred sulfonate polyesters are derived from dimethyl-5-sodiosulfo-1,3-phenylenedicarboxylate.

Preferred ionomer polyester polymer comprises divalent ionomer units represented by the formula II:

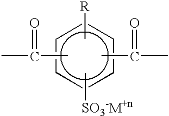

wherein R is hydrogen, halogen, alkyl or aryl; M is a metal, and n is 1-5.

A preferred polyester ionomer has the formula III:

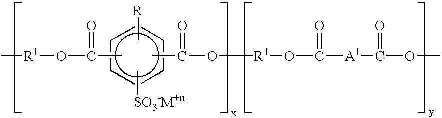

where the ionomer units, x, are from 0.1-50 mole percent of the polymer with 1.0 to 20 mole percent being preferred. X+y equals 100 mole percent. Most preferably R is hydrogen. When R is hydrogen, A¹ is phenylene, and R¹ is an alkylene radical of from C₁-C₁₂, preferably from C₂ or C₄, and x and y are in mole percent, then x is from about 1 to about 20 percent, and more preferably from about 1 to about 10 percent. The x and y units are expected to be randomly distributed along the polymer backbone.

A preferred polyester ionomer has the following formula IV:

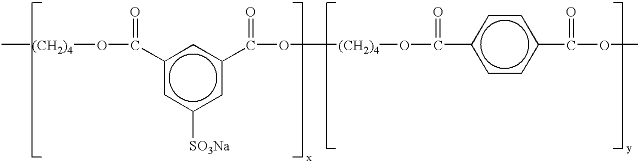

Typical glycol or diol reactants, R¹, include straight chain, branched, or cycloaliphatic alkane diols and may contain from 2 to 12 carbon atoms. Examples of such diols include but are not limited to ethylene glycol; propylene glycol, i.e., 1,2- and 1,3-propylene glycol; butane diol, i.e., 1,3- and 1,4-butane diol; diethylene glycol; 2,2-dimethyl-1,3-propane diol; 2-ethyl-2-methyl-1,3-propane diol; 1,3- and 1,5-pentane diol; dipropylene glycol; 2-methyl-1,5-pentane diol; 1,6-hexane diol; dimethanol decalin, dimethanol bicyclo octane; 1,4-cyclohexane dimethanol and particularly its cis- and trans-isomers; triethylene glycol; 1,10-decane diol; and mixtures of any of the foregoing. A preferred cycloaliphatic diol is 1,4-cyclohexane dimethanol or its chemical equivalent. When cycloaliphatic diols are used as the diol component, a mixture of cis- to trans-isomers may be used, it is preferred to have a trans isomer content of 70% or more. Chemical equivalents to the diols include esters, such as dialkyl esters, diaryl esters and the like.

Examples of aromatic dicarboxylic acid reactants, as represented by the dicarboxylated residue A¹ in formula III, are isophthalic or terephthalic acid, 1,2-di(p-carboxyphenyl)ethane, 4,4′-dicarboxydiphenyl ether, 4,4′ bisbenzoic acid and mixtures thereof. All of these acids contain at least one aromatic nucleus. Acids containing fused rings can also be present, such as in 1,4-1,5- or 2,6-naphthalene dicarboxylic acids. The preferred dicarboxylic acids are terephthalic acid, isophthalic acid or mixtures thereof.

The most preferred ionomer polyesters are poly(ethylene terephthalate) (PET) ionomers, and poly(1,4-butylene terephthalate) ionomers, (PBT), and (polypropylene terephthalate) (PPT) ionomers.

Also contemplated herein are the above polyester ionomers with minor amounts, e.g., from about 0.5 to about 15 percent by weight, of units derived from aliphatic acid and/or aliphatic polyols to form copolyesters. The aliphatic polyols include glycols, such as poly(ethylene glycol) or poly(butylene glycol). Such polyesters can be made following the teachings of, for example, U.S. Pat. Nos. 2,465,319 and 3,047,539.

The preferred poly(1,4-butylene terephthalate) ionomer resin used in this invention is one obtained by polymerizing an ionomer component comprising a dimethyl-5-sodiosulfo-1,3-phenylenedicarboxylate, from 1 to 10 mole %, a glycol component of at least 70 mole %, preferably at least 90 mole %, of tetramethylene glycol and an acid component of at least 70 mole %, preferably at least 90 mole %, of terephthalic acid, and polyester-forming derivatives therefore.

The glycol component should contain not more than 30 mole %, preferably not more than 20 mole %, of another glycol, such as ethylene glycol, trimethylene glycol, 2-methyl-1,3-propane glycol, hexamethylene glycol, decamethylene glycol, cyclohexane dimethanol, or neopentylene glycol.

The acid component should contain not more than 30 mole %, preferably not more than 20 mole %, of another acid such as isophthalic acid, 2,6-naphthalene dicarboxylic acid, 1,5-naphthalene dicarboxylic acid, 4,4′-diphenyldicarboxylic acid, 4,4′-diphenoxyethane dicarboxylic acid, p-hydroxy benzoic acid, sebacic acid, adipic acid and polyester-forming derivatives thereof.

It is also possible to use a branched polyester ionomer in which a branching agent, for example, a glycol having three or more hydroxyl groups is used to produce a branched polymer. Blends of polyesters ionomers with non sulfonate salt polyesters may also be employed as the polyester ionomer composition. For example, the invention may consist of a blend of a poly(butylene terephthalate) ionomer and an unmodified poly(butylene terephthalate) resin. Preferred non sulfonate salt polyesters are the alkylene phthalate polyesters.

It is preferred that the sulfonate salt polyester be present in amounts greater than or equal to the non sulfonate salt polyester.

The blends of this invention can be processed by various techniques including injection molding, blow molding, extrusion into sheet, film or profiles, compression molding, etc. They can also be formed into a variety of articles for use in, for example; electrical connectors, electrical devices, computers, building and construction, outdoor equipment, trucks and automobiles.

### EXAMPLES

The following examples illustrate the present invention, but are not meant to be limitations to the scope thereof.

Melt Viscosity (MV) was measured at 250° C. or 266° C. using a Tinius Olsen model UE4-78 rheometer, a weight of 21,600 g, and an orifice with a 0.042 inch diameter. Samples were dried 1 h at 150° C. prior to testing.

The process used to produce the poly(butylene terephthalate) ionomers (PBT-ionomers) described in the examples and reference materials to follow involved a combination of melt and solid state polymerization. In order to produce polymers with different endgroup compositions, a batch of melt polymerized material was split in half such the two halves differed in the residence time in the reactor. The half of the batch that was removed from the reactor first, always possessed a lower [COOH]/[OH] than the half of the batch removed from the reactor at a later time. This change in [COOH]/[OH] is due to a side reaction that occurs during the course of a polymerization of PBT or PBT-ionomer involving conversion of —OH end groups to —COOH via the formation of tetrahydrofuran (ref. Pilati et al., Polymer, vol. 22, issue 11, pgs. 1566, 1981).

A representative melt polymerization process used to produce the PBT-ionomers used to describe the invention is as follows: 125.9 lbs of dimethylterephthalate, 5.94 lbs. of dimethyl-5-sodiosulfo-1,3-phenylene dicarboxylate, 100.1 lbs. of 1,4-butanediol, and 43 mls. of tetraisopropyl titanate were charged to a 40CV Helicone reactor which was preheated to 130° C. The monomer mixture was then heated to 225° C. at a rate of 1.5° C./minute under atmospheric pressure and most of the methanol by-product removed by distillation. The mixture was then subjected to a gradual reduction in pressure at a rate of 20 mm Hg/minute while the temperature was simultaneously increased to 250° C. at a rate of 1.5° C./minute. After 132 minutes under vacuum, the first half of the batch (B1) was released from the reactor and chopped into granules. The remaining half of the batch (B2) was held in the reactor for 20 more minutes without vacuum before it was removed and chopped into granules. The melt viscosity of B1 measured at 250° C. and a shear rate of 100s⁻¹ was 2,400 poise while the melt viscosity of B2 was 2,300 poise. The [COOH] for B1 measured by potentiometric titration was 44 m.eq./kg while the [COOH] for B2 was 82 m.eq./kg.

A series of polymer samples differing in molecular weight was generated from both B1 and B2 using solid state polymerization. Since the granules of B1 and B2 were of a very nonuniform shape and size and the kinetics of solid state polymerization depends on the physical form of the polymer samples, B1 and B2 were extruded and pelletized into uniform, cylindrical pellets about 2 mm in diameter and 4 mm in length. Extrusion was done at 235° C. using a single screw extruder. With the pellets of uniform size and shape, solid state polymerization was conducted. B1 was solid state polymerized as follows: Approximately 20 lbs. of B1 pellets was added to a 15 gallon, glass-lined vessel equipped with an overhead stirrer and a hot nitrogen purge (˜220° C.). The pellets were heated to about 207° C. while being stirred and purged with hot nitrogen flowing at a rate of 1.85 S.C.F.M. Small samples (˜80 g) were removed from the vessel with time and the [COOH] and [OH] measured by potentiometric titration and infrared spectroscopy, respectively. From the [COOH] and [OH], Mn was calculated as follows:

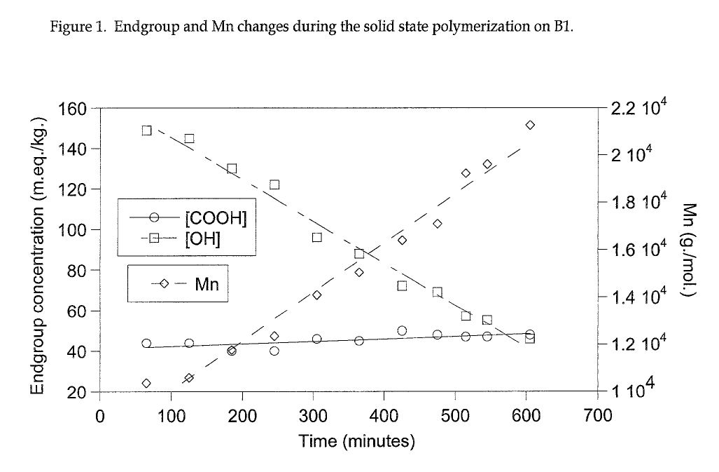

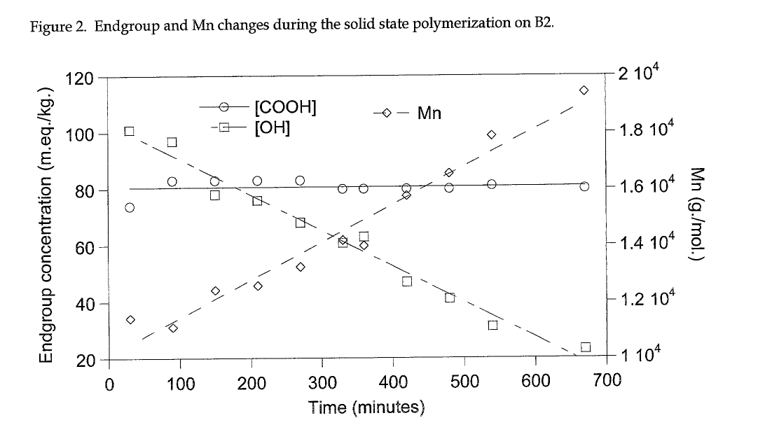

2×10⁶/([OH]+[COOH])

where [OH] and [COOH] are expressed as m.eq./kg. FIGS. 1 and 2 illustrate the change in [COOH], [OH], and Mn with time for B1 and B2, respectively. When an Mn of interest was reached, a 5 lb. sample of material was removed and further characterized and represent an Example or Reference material of the invention. For example, Example 6 represents a sample that was removed during the solid state polymerization of B1 after 8 hours of reaction and Reference 7 represents a sample that was removed during the solid state polymerization of B2 at a reaction time of 12 hours. As shown in FIGS. 1 and 2, the [COOH] remained essentially constant during the solid state polymerization. This behavior was observed for all of the solid state polymerizations conducted to produce the Example and Reference materials of this invention.

As shown in Table I, the presence of the sodium sulfonate functionality has a dramatic effect on polymer properties. For example, melt viscosity, and impact strength were increased by the introduction of sulfonate groups while crystallization temperature was decreased. The high melt viscosity and reduced crystallization temperature imparted by the sulfonate functionality may be useful for producing materials designed for blow molding or thermoforming applications.

The data displayed in Tables I-III, shows that, at similar molecular weight (Mn) and equivalent sodium sulfonate content (%SO₃Na), increasing the ratio of carboxylic acid end groups to hydroxyl end groups decreases melt viscosity and impact strength and increases crystallization temperature. Thus, increasing the —COOH/OH end group ratio diminishes the effect of the sulfonate groups. As a result, PBT-ionomers with low —COOH/—OH end group ratio are preferred in order to maximize the beneficial effects imparted by the presence of the sulfonate containing comonomer.

The measurement error for the data shown in Tables I-III was determined by calculating a pooled standard deviation for each of the measurements. The standard deviation for apparent viscosity (η*) notched Izod impact strength (N.I.), and crystallization temperature (Tc) was 500 poise, 0.091 ft.lb./in., and 0.44° C., respectively.

1. A polyester ionomer composition comprising an alkylene aryl polyester copolymer having metal sulfonate units represented by the formula IA: 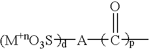
or the formula IB:
(M⁺ⁿO₃S)_{d}—A—(OR″O)_{p—}
where p=1-3, d=1-3, p+d-2-6, n+1-5, M is a metal, and A is an aryl group containing one or more aromatic rings where the sulfonate substituent is directly attached to an aryl ring, R″ is a divalent alkyl group and the metal sulfonate group is bound to the polyester through ester linkages, and having end groups consist essentially of carboxylic acid groups (—COOH) and hydroxyl groups (—OH) having a ratio of —COOH/—OH of 0.10 to 5.00.

2. A polyester ionomer composition according to claim 1 wherein —COOH/—OH is 0.10 to 3.00.

3. A polyester ionomer composition according to claim 1 wherein —COOH/—OH is 0.10 to 2.00.

4. A polyester ionomer composition according to claim 1 wherein —COOH/—OH is 0.10 to 1.00.

5. A polyester ionomer composition according to claim 1 having the formula III: 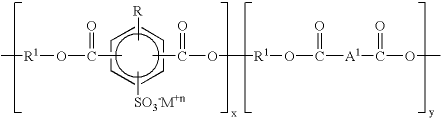
where the ionomer units, x, are from 0.1-50 mole %, R is halogen, alkyl, aryl, alkylaryl or hydrogen, R¹ is derived from a diol reactant comprising straight chain, branched, or cycloaliphatic alkane diols and containing from 2 to 12 carbon atoms, A¹ is a divalent aryl radical. X+y is equal to 100 mole percent.

6. A polyester ionomer composition of claim 5 wherein R is hydrogen, x=0. 5-20 mole percent, R¹ is C₂-C₈ alkyl, and Al is derived from iso- or terephthalic acid or a mixture of the two.

7. A polyester ionomer according to claim 6 where p=2, d=1, and M is zinc, tin, alkaline or alkaline earth metal.

8. A polyester ionomer composition of claim 6 wherein the metal sulfonate polyester of formula III is a alkylene polyester wherein A¹ is the residue from a diacid component of iso- or terephthalic acid and derivatives thereof and R¹ is the residue from a diol component selected from the group consisting essentially of ethylene glycol, propanediol, butanediol, or cyclohexanedimethanol, and derivatives thereof.

9. A polyester ionomer resin composition of claim 6 where the metal sulfonate salt is iso- or tere-sulfo phthalate.

10. A polyester ionomer resin composition of claim 6 wherein x is from about 1 to about 15 percent.

11. A polyester ionomer resin composition of claim 6 wherein x is from about 1 to about 12 percent.

12. A polyester ionomer resin composition of claim 6 wherein x is from about 1 to about 10 percent.

13. A polyester ionomer resin composition having the formula: 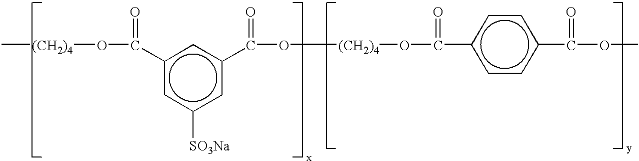
where the ionomer units, x, are from 0.1-20 mole % and the end groups consist essentially of carboxylic groups (—COOH) and hydroxyl groups (—OH) having a ratio of —COOH/—OH of 0.10 to 5.00.
